(19) United States
(12) Patent Application Publication
(10) Pub. No.: US 2026/0304080 A1
(43) Pub. Date: Oct. 1, 2026

(54) ENHANCEMENT ON USER EQUIPMENT (UE)-SIDE AI/ML DATA MANAGEMENT

(71) Applicant: RAKUTEN MOBILE, INC., Tokyo (JP)

(72) Inventor: Awn Muhammad, Tokyo (JP)

(73) Assignee: RAKUTEN MOBILE, INC., Tokyo (JP)

(21) Appl. No.: 19/629,464

(22) Filed: Mar. 26, 2026

Related U.S. Application Data
(60) Provisional application No. 63/779,053, filed on Mar. 27, 2025.

(51) Int. Cl. H04W 4/38; H04B 17/318; H04L 41/16; H04W 76/20

(52) U.S. Cl. CPC H04W 4/38; H04B 17/318; H04L 41/16; H04W 76/20

(57) ABSTRACT

Example embodiments relate to enhancement on user equipment-side (UE-side) Artificial Intelligence and/or Machine Learning (AI/ML) data management. According to example embodiments, a system may include a network entity configured to receive, from a UE, a request message associated with a request for a data collection session for collecting data associated with an AI/ML model. The request message may include at least one of: an identifier (ID) associated with a measurement set, a collection intent indicating a purpose of the data collection session, or a preferred window indicating a suggestion on time-domain information for the data collection session. Further, the network entity may transmit a response message to the UE. The response message includes at least one of: an acceptance of the data collection session, a rejection of the data collection session, or a deferral of the data collection session.

### CROSS REFERENCE TO RELATED APPLICATION

This application claims priority to U.S. Provisional Patent Application No. 63/779,053, filed with the U.S. Patent and Trademark Office on Mar. 27, 2025, the entire contents of which are incorporated herein by reference.

### TECHNICAL FIELD

The present disclosure relates to enhancement on user equipment-side (UE-side) Artificial Intelligence and/or Machine Learning (AI/ML) data management.

### BACKGROUND

The information disclosed in this background section is only for the enhancement of understanding of the general background of the disclosure and should not be taken as an acknowledgement or any form of suggestion that this information forms the prior art already known to a person skilled in the art.

In modern wireless communication systems or networks (e.g., 5G New Radio (NR)-based networks, Open Radio Access Network (O-RAN)-based networks, etc.), Artificial Intelligence (AI) and/or Machine Learning (ML) are increasingly utilized via the telecommunication systems or networks. A specific configuration may involve the deployment (e.g., training, updating, executing, etc.) of AI/ML models for the benefit, optimization, or service provisioning of an individual User Equipment (UE). For instance, the UE may communicate with one or more network entities (e.g., a base station, a Radio Access Network (RAN) node, a core network entity, etc.) for the purposes of, for example, storing the AI/MWL models and/or associated data (e.g., in a server, etc.), sharing the AI/ML models and/or associated data with other devices (e.g., sending the AI/ML models/data to another devices via the one or more network entities, etc.), utilizing the AI/ML models and/or the associated data for UE-specific purposes (e.g., executing the AI/ML models for providing individual AI/ML inference, optimizing the performance of a specific UE based on its unique environment, etc.), and the like.

In the aforesaid configuration, the AI/ML models may be implemented locally at the UE, implemented in one or more external devices (e.g., cloud servers, edge servers, etc.) with which the UE communicates via the one or more network entities, implemented within the one or more network entities themselves as a UE-specific instance, or a combination thereof. For descriptive purposes, such a configuration may be referred to as the “UE-side AIML” herein.

The deployment and continuous operation of the UE-side AI/MVL may involve the collection and processing of massive amounts of data characterized by a wide range of varieties and temporal dynamics. Effective and efficient management of this high-volume, heterogeneous data (“AI/ML data” herein) is critical to enable accurate and reliable AI/ML-driven operations, as the performance of the AI/ML models relies on the comprehensiveness, completeness, and timeliness of the AI/ML data utilized for training and inference.

### SUMMARY

Example embodiments of the present disclosure provide systems, methods, and the like, that effectively and efficiently enhance UE-side AI/ML data management.

According to example embodiments, a system may include a network entity that may be configured to receive, from a UE, a request message associated with a request for a data collection session for collecting data associated with an AI/ML model. The request message may include at least one of: an identifier (ID) associated with a measurement set, a collection intent indicating a purpose of the data collection session, or a preferred window indicating a suggestion on time-domain information for the data collection session. Further, the network entity may transmit a response message to the UE. The response message includes at least one of: an acceptance of the data collection session, a rejection of the data collection session, or a deferral of the data collection session.

According to example embodiments, a method may include receiving, by a network entity and from a UE, a request message associated with a request for a data collection session for collecting data associated with an AI/ML model. The request message may include at least one of: an ID associated with a measurement set, a collection intent indicating a purpose of the data collection session, or a preferred window indicating a suggestion on time-domain information for the data collection session. Further, the method may include transmitting, by the network entity, a response message to the UE. The response message includes at least one of: an acceptance of the data collection session, a rejection of the data collection session, or a deferral of the data collection session.

According to example embodiments, a non-transitory computer-readable recording medium having recorded thereon instructions executable by a network entity to cause the network entity to perform a method. The method may include receiving, from a UE, a request message associated with a request for a data collection session for collecting data associated with an AI/ML model. The request message may include at least one of: an ID associated with a measurement set, a collection intent indicating a purpose of the data collection session, or a preferred window indicating a suggestion on time-domain information for the data collection session. Further, the method may include transmitting a response message to the UE. The response message includes at least one of: an acceptance of the data collection session, a rejection of the data collection session, or a deferral of the data collection session.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example system configuration, according to one or more example embodiments;

FIG. 2 to FIG. 8 each illustrates an example method, according to one or more example embodiments;

FIG. 9 illustrates an example device/apparatus that may implement one or more example embodiments; and

FIG. 10 illustrates an example environment in which systems, devices, and/or methods, according to one or more example embodiments, may be implemented.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

It shall be noted that, descriptions of example embodiments of the present disclosure may include terms and names defined in one or more standard organizations, such as the Open Radio Access Network (O-RAN) Alliance, the 3rd Generation Partnership Project (3GPP) standard organization, the European Telecommunications Standards Institute (ETSI) standard organization, and the like. For instance, the terms “NG-RAN,” “RRC message,” “MAC CE,” “IE,” “QFI,” “SDAP,” “MDT,” “CSI,” “CSI-RS,” “SSB,” “DRB,” “SDAP header,” “UAI,” “ASN.1,” and the like, as well as the associated features, operations, interfaces, and messages involved therein, are to be interpreted as consistent with those specified in one or more technical specifications, unless being described otherwise.

In the present disclosure, specific tasks may be performed using Artificial Intelligence and/or Machine Leaning (AI/ML) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc. In the following, terms like “the AI model” may refer to “one or more AI models,” “one or more ML models,” “one or more AI models and ML models,” and the like.

Although AI and ML may be explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

As described above, in a user equipment-side (UE-side) AI/ML configuration, a UE may communicate with one or more network entities (e.g., base station, radio access network (RAN), core network, etc.) to implement or deploy (e.g., trains, updates, executes, etc.) one or more AI/ML models to utilize UE-related operations or services (e.g., storing/sharing the AI/ML models or the associated data with other devices, training the AI/ML models online, enabling network optimization for the specific UE, etc.). In this regard, the efficacy and accuracy of these AI/ML models may rely on the quality, timeliness, and completeness of the data utilized for implementing the AI/ML models.

As also described above, the deployment and continuous operation of the UE-side AI/ML configuration may involve the collection and processing of massive amounts of data (“AI/ML data” herein). This AI/ML data may be characterized by a wide range of varieties and temporal dynamics. In this regard, a major portion of these high-volume, heterogeneous data may be collected or aggregated by one or more UEs, such as customer devices (e.g., smartphones, tablets, wearables, etc.), specialized terminals (e.g., vehicles, industrial internet of things (IoT) sensors, etc.), and the like. Further, the AI/ML data may include, for example, radio/network-related data (e.g., Channel State Information (CSI), Signal-to-Interference-plus-Noise Ratio (SINR), beam measurements, etc.), UE-related data (e.g., power consumption, supported features, operational states, etc.), user-related data (e.g., application usage statistics, traffic demand patterns, mobility routines, etc.), AI/ML-related data (e.g., model training parameters, AI/ML model weight, etc.), and the like.

In view of the above, the communication among UE and the network entity(s) is a critical aspect in managing AI/ML data for UE-side AI/ML deployment. For instance, the signaling between the network component(s) and the UE may affect how efficient and effective the network component(s) may inform the UE regarding the specific requirements for collecting AI/ML data for UE-side AI/MVL deployment, such as the precise conditions under which data collection/logging should be initiated, when the UE may transmit the collected AI/ML data, and the like. Similarly, the quality of this communication may determine the ability of the UE to accurately capture and timely report the targeted AI/ML data to the network component(s), ensuring that the collected datasets are sufficiently comprehensive for UE-side AI/ML deployment while minimizing the transmission of redundant information and reducing the signaling overhead on the radio interface.

Nevertheless, data management mechanisms in the related art, such as Minimization of Drive Tests (MDT) or standard periodic measurement reporting, have been used for general network optimization (coverage analysis, failure detection) and were not originally designed to meet the rigorous and dynamic requirements of AI/ML-related operations, such as AI/ML model training, AI/ML model inference, and the like. Rather, there is room to enhance the mechanisms available in managing the UE-side AI/ML data. In the following, the shortcomings of the related art are described according to below aspects:
(1) UE-Initiated Collection Requests and Network Handling;
(2) Network-Controlled Constraints for UE-Side Data Collection;
(3) Differentiation and Control of AI/ML Data on the User Plane;
(4) Scheduling Flexibility and Congestion Control for AI/ML Uploads;
(5) Maintaining Data Collection Context Across Mobility and RRC State Transitions; and
(6) Runtime Control of Ongoing Collection Sessions.

Regarding aspect (1), the concept of allowing the UE to request or initiate data collection session via RRC signaling is introduced in the related art. Nevertheless, the structures and semantics of the request message remain undefined and non-standardized in the related art. Specifically, in practices, the data collection session for collecting AI/ML data (“AI/ML data collection” herein) may involve distinct measurement resource groups (e.g., channel state information reference signals (CSI-RS), etc.), associated model IDs, timing preferences, and the like. Without defined or standardized structures or fields in the request message from the UE, the network may lack sufficient context to make informed decisions about whether to authorize, defer, or reject the requested data collection session.

Further, the network's policy in handling the requests from the UE remains unspecified or non-standardized. To support consistent behavior across vendors, the network's decision in accepting, deferring, or rejecting the requests for AI/ML data collection session may need to be explicitly supported at the protocol level.

Regarding aspect (2), although full scheduling of AI/ML data collection by the network may not be desirable due to signaling overhead, network operators may need a means to define basic constraints of the scheduling of the AI/ML data collection, such as how frequently UEs can collect data, when data collection is allowed, and the like. These constraints may enable resource planning and reduce the risk of uplink congestion caused by overlapping data collection sessions from multiple UEs. Nevertheless, the absence of network-defined constraints for collection frequency and timing in the related art may lead to uncontrolled uplink behavior and complicate scheduling.

Regarding aspect (3), AI/ML data collected by the UE may be transported to the network via existing signaling mechanisms, such as Data Radio Bearers (DRBs), Quality of Service (QoS) Flow Identifier (QFI)-based flows, or the like, on the User Plane. However, when the AI/ML data is transported via the existing signaling mechanisms, the AI/ML data flows or traffics may be indistinguishable from other best-effort traffics at the network level, which may limit the network's ability to apply differentiated scheduling policies or resource treatment to the AI/ML data flows or traffics. Furthermore, in network cells experiencing high uplink load conditions, uncontrolled AI/ML data uploads or traffics may interfere with latency-sensitive services (e.g., Voice over New Radio (VoNR), real-time gaming/streaming applications, etc.).

Given that AI/ML data may be delay-tolerant in certain use cases (e.g., background model training, etc.), the network may benefit from delaying, throttling, or deprioritizing such AI/ML data traffic relative to more time-critical services. However, implementing such differentiated treatment may require identification mechanisms at the Service Data Adaptation Protocol (SDAP) layer (or equivalent protocol layers) to distinguish AI/ML data traffic from other User Plane traffics. In the related art, AI/ML data flows remain opaque to the network and cannot be selectively deprioritized or traffic-shaped unless they are carried in dedicated DRBs (e.g., DRBs with specific QoS configurations, etc.), which is an approach that may not always be justified given the associated resource overhead and configuration complexity.

Regarding aspect (4), multiple UEs may collect and locally store substantial amounts of measurement data associated with AI/ML operations, and may subsequently upload such data asynchronously during idle periods or low-load conditions. However, the network may lack standardized mechanisms to advise UEs regarding optimal upload timing or to dynamically delay/throttle data uploads during periods of network congestion. Given that AI/ML data uploads may be able to tolerate moderate latency without adversely affecting AI/ML model performance, such traffic may be well-suited for scheduled or rate-controlled transmission approaches.

Nevertheless, in the related art, there is no defined Radio Resource Control (RRC)-level mechanism that enables the network to advise the UEs regarding the network-preferred configuration (e.g., timing, duration, etc.) for AI/ML data uploads. Similarly, there is no congestion signaling mechanism specific to AI/ML data traffic that would allow the network to dynamically adjust AI/ML data upload behavior based on real-time (or near-real-time) network conditions. This absence of upload configuration control and congestion management mechanisms may result in suboptimal utilization of uplink resources and may contribute to congestion during peak usage periods.

Regarding aspect (5), multiple UEs collecting data for A/ML model training or other AI/ML purposes may operate over extended time windows and may remain in the same data collection session across multiple network cell changes due to mobility events (e.g., handovers, etc.) or RRC state transitions. In the related art, there is no specified or standardized mechanism to ensure that the associated data collection configuration (e.g., measurement resources such as CSI-RS or Synchronization Signal Blocks (SSB), collection intent parameters, associated identifiers, etc.) remains valid in the target network cell following a mobility event and/or RRC state transition. If such a configuration context is not properly maintained across mobility events/RRC state transitions, the result may cause unintended gaps in data collection, inefficient utilization of radio resources, or inconsistencies in the collected data that may adversely affect AI/ML model quality.

While the mechanisms in the related art (e.g., existing handover mechanisms, etc.) may support the transfer of measurement configurations and DRB context between the source network cell and target network cell, there is no equivalent mechanism for transferring data collection session metadata specific to AI/ML operations. In the absence of such a mechanism, the UE may be required to treat each mobility event/RRC state transition as the termination of an existing AI/ML data collection session and subsequently re-request a new AI/ML data collection session from the target network cell, which is an approach that may introduce additional signaling overhead, cause delays in AI/ML data collection continuity, and result in the risk of data collection session fragmentation and inconsistent training inputs (since data collection context may not be preserved across the mobility events). This limitation may be particularly problematic in deployment scenarios involving distributed model training architectures, where continuity of collected AI/ML data under stable measurement assumptions may be important for maintaining AI/ML model quality and training convergence.

Regarding aspect (6), although data collection sessions for AI/ML purposes may be initiated through network configuration, such sessions may not always be suitable for continuous operation without adaptive control mechanisms. In practical deployment scenarios, various conditions may change dynamically during an ongoing AI/ML data collection session, including UE power conditions (e.g., battery level, thermal status), network cell load conditions, available uplink scheduling capacity, and the like. Such dynamic variations may necessitate temporary throttling or suspension of data collection activities to accommodate changing network conditions and/or to preserve UE resources. However, the related art offers only binary control mechanisms (i.e., start and stop) through configuration or reconfiguration procedures. This binary approach may increase control-plane signaling overhead and may limit operational flexibility, particularly in scenarios requiring rapid or temporary adjustments to collection behavior. A lighter-weight control interface may be beneficial for scenarios where the network prefers to momentarily pause an AI/ML data collection session due to transient congestion conditions or to temporarily reallocate resources to delay-sensitive services without terminating the entire AI/ML data collection session. Network operators deploying AI/ML-based features at scale may be particularly concerned about the potential for background collection traffic to overwhelm uplink scheduling queues during peak usage hours. The network may benefit from suppressing low-priority collection activities during such periods without requiring complete session teardown or full reconfiguration. Nevertheless, in the related art, there is no defined or standardized support for temporary suspension or resumption of AI/ML data collection sessions by the network without invoking full reconfiguration procedures.

Example embodiments of the present disclosure provide systems, methods, mechanisms, and the like, that efficiently and effectively address one or more of the problems described above, thereby enhancing the management of data collection associated with UE-side AI/ML.

Firstly, with respect to aspect (1), example embodiments of the present disclosure introduce and exemplify a mechanism that effectively and efficiently enhances the UE-initiated data collection request and network policy in handling the request, thereby addressing the shortcomings of aspect (1) as described above.

By implementing the example embodiments, a new request message that includes AI/ML-related information may be utilized by the UE to request or initiate the AI/ML data collection session. For instance, the request message may include an RRC message that includes one or more information elements (IEs) associated with one or more of: an ID associated with a measurement set (e.g., a previously configured resource group, etc.), a collection intent indicating a purpose of the requested data collection session (e.g., training the AI/ML model, monitoring the performance of the AI/ML model, etc.), a preferred window indicating a suggestion on time-domain information (e.g., start time, duration, etc.) for the data collection session, and the like.

The network entity, upon receiving the request message from the UE, may appropriately or dynamically make a decision (e.g., accept, defer, reject, etc.) to the requested data collection session based on the AI/ML-related information included in the request message, and then provide an associated response message to the UE. The response message may include at least one of: an acceptance of the data collection session, a rejection of the data collection session, or a deferral of the data collection session. In this regard, if the response message includes the rejection of the data collection session, the response message may further include at least one of: a rejection cause indicating a reason for the rejection (e.g., a network cell load constraint, resource unavailability, etc.), or a retry window indicating a time period after which the UE can retry the request. According to example embodiments, the retry window may instruct the UE that it should not retry the request immediately after the rejection but should follow the configured backoff period before re-initiating the request for the data collection session.

Accordingly, by implementing the example embodiments, the network entity may effectively receive structured, standardized request messages from the UE that include sufficient context (e.g., measurement set ID, collection intent, preferred window, model ID, etc.) to make informed decisions about whether to authorize, defer, or reject the UE's request for the AI/ML data collection session. Further, the network entity may provide consistent, protocol-level responses that support acceptance, rejection, or deferral of AI/ML data collection sessions. When rejecting requests, the network entity may provide rejection causes and retry windows, enabling the UE to implement appropriate backoff behavior rather than immediately retrying the request. In view of the above, example embodiments may enable consistent behavior across vendors and may provide the network with sufficient context for informed decision-making regarding AI/ML data collection sessions. The standardized request/response structure may address the shortcomings of aspect (1) by defining the structures and semantics of UE-initiated collection requests and network handling policies.

With respect to aspect (2), the example embodiments of the present disclosure introduce and exemplify a mechanism that effectively and efficiently implements network-controlled constraints for UE-side data collection. Specifically, the network entity may be configured to transmit, to the UE, a message that includes an AI/ML data collection configuration. The AI/ML data collection configuration may include one or more network-controlled constraints for the data collection behavior at the UE. For instance, the AI/IL data collection configuration may include at least one of: a parameter that limits the per-UE contribution to data collection, or a parameter that defines allowed time periods during which the UE is permitted to perform data collection. Upon receiving the message from the network entity, the UE may collect AI/ML data according to the provided AI/ML data collection configuration, thereby adhering to the network-defined constraints.

Accordingly, by implementing the example embodiments, the network entity may enable network-controlled constraints for UE-side data collection, allowing network operators to define parameters such as how frequently UEs are permitted to collect AI/ML data, when AI/ML data collection is allowed, and the like. These network-defined constraints may enable more effective resource planning and may reduce the risk of uplink congestion that could otherwise result from overlapping or concurrent data collection activities across multiple UEs within a network cell. The introduced constraint parameters may address the shortcomings of aspect (2) by providing mechanisms for defining network-controlled constraints for collection frequency and timing.

With respect to aspect (3), example embodiments of the present disclosure introduce and exemplify a mechanism that enables effective and efficient differentiation and control of AI/ML data on the User Plane. Specifically, the network entity may be configured to transmit, to the UE, a message that includes a configuration for marking AI/ML traffic. According to example embodiments, the configuration may instruct or be utilized by the UE to perform Service Data Adaptation Protocol (SDAP)-level marking on the AI/ML traffic using existing SDAP header extension fields. The message may include a field that includes one or more values associated with a purpose of the AI/ML traffic. The purpose of the AI/ML traffic may include, for example, AI/ML model training, inference feedback, diagnostics, and the like. Upon receiving the configuration from the network entity, the UE may mark the AI/ML data with the associated purpose indicator when transmitting the AI/ML data to the network entity.

Accordingly, by implementing the example embodiments, the network entity may receive, from the UE, a message that includes AI/ML data and the field that indicates the purpose of the associated AI/ML traffic. By receiving the message that includes the field indicating the purpose of the AI/ML traffic, the network entity may identify and differentiate the AI/ML traffic based on its purpose, thereby enabling the network entity to apply appropriate scheduling rules and traffic management policies that distinguish between user traffic and AI/ML traffic (e.g., traffic for transmitting internal UE-generated AI/ML data, etc.). Thus, example embodiments introduce a data marking mechanism that may address the shortcomings of aspect (3) by providing identification mechanisms that allow the network to differentiate AI/ML traffic from other User Plane traffics without requiring dedicated DRBs.

With respect to aspect (4), example embodiments of the present disclosure introduce and exemplify mechanisms that effectively and efficiently enhance scheduling and congestion control for AI/ML data uploads. Specifically, the network entity may be configured to transmit, to the UE, a message that includes an AI/ML data upload configuration. The AI/ML data upload configuration may include the preferred time windows and/or conditions for AI/ML data upload. If this information is omitted, the UE may be free to upload AI/MVL data at its discretion. By including this information, the network entity may advise the UE regarding optimal upload timing without requiring strict scheduling control. Alternatively or additionally, the AI/ML data upload configuration may include an indicator that indicates various upload modes such as: full-rate upload allowed (e.g., no restriction), pause/terminate AI/ML upload temporarily, or reduce rate to a specified maximum rate for a specified duration (e.g., in seconds, etc.). This throttling indicator may be implemented as a part of an RRC message and/or a Medium Access Control (MAC) Control Element (CE), and may be mapped to uplink scheduling behavior or Data Radio Bearer (DRB) suspension.

Accordingly, by implementing the example embodiments, the network entity may advise one or more UEs regarding optimal upload timing through the preferred time window configuration, and may dynamically control AI/ML data uploads during congestion through the throttling indicator. These mechanisms may enable the network to suggest optimal upload configuration dynamically during periods of network congestion, thereby addressing the shortcomings of aspect (4) as described above.

With respect to aspect (5), example embodiments of the present disclosure introduce and exemplify mechanisms that effectively and efficiently enhance the maintenance of data collection context across mobility events and RRC state transitions. Specifically, upon determining a mobility event (e.g., detection that a handover is required, etc.) and/or a RRC state transition, the network entity may be configured to extend handover preparation signaling to optionally include information associated with an ongoing AI/ML data collection session. For instance, the network entity may generate a message (e.g., a handover command) that includes context information associated with the active AI/ML data collection configuration, such as: an identifier (ID) associated with the configuration of the AI/ML data collection session, measurement resources (e.g., CSI-RS, SSB, etc.), session timing information (e.g., start time, duration, data collection time window, maximum samples per measurement, etc.), or the like. Accordingly, the network entity may transmit the message to the UE and/or the associated target network entity of a target network cell. Upon successful handover/RRC state transition, the target network cell may either continue the data collection session based on the transferred context or trigger a reconfiguration as appropriate.

Additionally, example embodiments of the present disclosure also introduce a mechanism for addressing a scenario where the context transfer is not possible or fails. Specifically, in such scenarios, example embodiments define a behavior for the UE to indicate its ongoing data collection state to the target base station immediately post-handover. This indication may be provided via UE Assistance Information (UAI) or an AI/ML Data Collection Status message. By implementing this fallback mechanism, the target network cell may be informed of the UE's ongoing AI/ML data collection activities and may take appropriate actions to continue or reconfigure the AI/ML data collection session.

Accordingly, by implementing the example embodiments, data collection context may be preserved across intra-mobility events such as handovers, preventing session fragmentation and inconsistent training inputs that could adversely affect AI/ML model quality. The context transfer mechanism and the fallback UE indication mechanism may address the shortcomings of aspect (5) by providing standardized mechanisms for transferring data collection session metadata across mobility events.

With respect to aspect (6), example embodiments of the present disclosure introduce and exemplify mechanisms that effectively and efficiently enhance runtime control of ongoing data collection sessions. Specifically, the network entity may be configured to transmit lightweight signaling (e.g., an RRC message, a MAC CE, etc.) to suspend or resume an AI/ML data collection session at the UE without requiring full reconfiguration procedures. The expected UE behavior (upon receiving a suspension indication) may include: buffering ongoing data, avoiding measurement transmission, and preparing to resume data collection within the active configuration window upon receiving a resumption indication.

Additionally, example embodiments introduce and exemplify mechanisms that allow the network to broadcast a network/cell-level indicator that is applicable to multiple UEs using shared configurations. This network/cell-level indicator may provide coarse-grain control during load surges, allowing the network to temporarily suppress AI/ML data collection activities across multiple UEs simultaneously without requiring individual signaling to each UE.

Accordingly, by implementing the example embodiments, the network entity may temporarily suspend or resume data collection without invoking full reconfiguration procedures, providing lightweight control mechanisms for transient congestion conditions or temporary resource reallocation scenarios. The lightweight suspension/resumption signaling and the cell-level suspension indicator may address the shortcomings of aspect (6) by providing standardized support for temporary suspension or resumption of data collection by the network.

In view of the above, example embodiments of the present disclosure introduce and exemplify various mechanisms that may address the shortcomings of the above-described aspects (1)-(6), thereby enabling effective and efficient enhancement of UE-side AI/ML data management.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture and Configurations

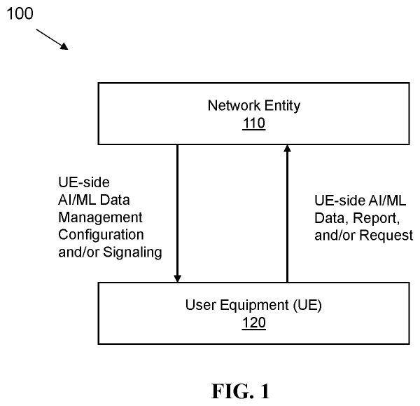

FIG. 1 illustrates a generic system configuration 100, according to one or more example embodiments. As illustrated in FIG. 1, the system configuration 100 includes a network entity 110 and a user equipment (UE) 120. The network entity 110 may be communicatively coupled to the UE 120 via one or more networks and/or interfaces, and may be configured to exchange information or messages for UE-side AI/ML purposes.

As described above, in a UE-side AI/ML configuration, one or more UEs may communicate with one or more network entities for the communication of data associated with one or more AI/ML models and/or AI/ML-related operations (“AI/ML data” herein). For descriptive purposes, it may be assumed that the UE 120 communicates with the network entity 110 (and/or one or more devices via the network entity 110).

In the UE-side AI/ML configuration, the AI/ML model(s) may be implemented or deployed (e.g., trained, updated, executed, etc.) in one or more of: (a) the UE 120, which acts as the entity that collects and provides the AI/ML data; (b) one or more devices (e.g., another UE, a server, an edge node/terminal, etc.) with which the UE 120 is communicating via the network entity 110; and (c) the network entity 110 (in this configuration, the UE 120 may, but not necessarily, communicate with the one or more devices (e.g., the another UE, etc.) via the network entity 110).

In this regard, “UE-side AI/ML purposes,” “AI/NL-related operations,” and similar descriptions as used herein may include any suitable type of operations associated with the lifecycle or utilization of at least one AI/ML model for the UE 120, such as, but not limited to, one or more of: (a) general model and/or data management (e.g., storing the AI/ML model or associated data, sharing the model/data with other devices or the network, updating the model/data, etc.), (b) collaborative learning and/or inference (e.g., implementing distributed training architectures such as federated learning that computes local data at the UE 120 and transmitting them to a global device/server, performing split inference such as executing a portion of inference at the UE 120 and offloading the subsequent portions of inference to an edge device or network entity, etc.), (c) UE-specific service provisioning (e.g., executing the AI/ML model to provide application-level enhancements or automations, such as contents generation, gaming rendering, security threat detection and responding, etc.), and (d) UE-specific network optimization (e.g., utilizing the AI/ML data or model inference outputs to optimize the specific radio link or performance of the UE 120, optimizing UE power-saving opportunity by predicting UE traffic and optimizing Discontinuous Reception (DRX) configurations, facilitating seamless handovers by performing mobility prediction, etc.).

Further, the “AI/ML data” or “logs” described herein may include data associated with the network, the UE, or any other suitable data, that may be utilized by the network entity 110, the UE 120, and/or other devices, for UE-side AI/ML purposes. For instance, the AI/ML data may include, but not limited to, one or more of: radio measurement data (e.g., signal strength, interference trends, etc.), beam-related data (e.g., beam transitions, beam-level metrics, etc.), Channel State Information (CSI)-related data (e.g., CSI measurement trends, CSI feedback, etc.), mobility-related data (e.g., handover parameters, trajectory logs, mobility patterns, etc.), UE-internal status data (e.g., power consumption, storage availability, battery level, thermal status, computing load, motion trajectory, beam selection metric, application requirements, etc.), AI/ML-related metadata (e.g., dataset classification/categorization information, model identifiers, performance feedback, model weights or gradients, intermediate layer activations, loss function values, etc.), and the like.

The network entity 110 may include one or more physical or logical network nodes within a network (e.g., 4G LTE network, 5G network, Open Radio Access Network (O-RAN)-based network, etc.) that may be configured to perform management, control, and/or data processing for UE-side AI/ML data. For instance, the network entity 110 may include, but is not limited to: a base station (e.g., a 4G eNodeB, a 5G gNodeB, etc.), a RAN node (e.g., Next Generation RAN (NG-RAN), Open RAN (O-RAN), etc.) or an associated component (e.g., a Radio Intelligent Controller (RIC), a Centralized Unit (CU), etc.), a core network function or entity (e.g., an Access and Mobility Management Function (AMF), a User Plane Function (UPF), a Network Data Analytics Function (NWDAF), etc.), an AI/ML management or orchestration node, a cloud-based server, or any other suitable network node that may be configured to interoperate with the UE 120 to manage or deploy AI/ML model(s) for UE-side AI/ML purposes.

The UE 120 may include any suitable device, terminal, apparatus, or system that may communicate with the network entity 110 via a wireless connection, a wired connection, or a combination thereof. The UE 120 may also communicate with the network entity 110 via any suitable interfaces, such as those defined in one or more technical documents of one or more standard organizations (e.g., 3GPP, O-RAN Alliance, etc.). By way of example, the UE 120 may include, but is not limited to: a mobile device (e.g., a mobile phone/smartphone, a tablet, a laptop, a wearable device such as smartwatches and smartglasses, a portable hotspot, a wireless sensor, etc.), a static device (e.g., an Internet of Things (IoT) device such as sensors and smart home/office devices, an internet router, a personal computer (PC), etc.), a combination of mobile devices and/or a static devices (e.g., a high-performance computing (HPC) system, a cloud cluster, etc.), a vehicle to everything (V2X) communication terminal, a drone or unmanned aerial vehicle (UAV), or any other suitable terminal or device that may be configured to provide or report data to the network entity 110 for UE-side AI/MWL purposes. In some example embodiments, the UE 120 may communicate with one or more devices (e.g., another UE, an edge node, etc.).

As illustrated in FIG. 1, the network entity 110 and UE 120 may communicate and interoperate with each other to facilitate the management of AI/ML data or datasets involved in or associated with UE-side AI/ML purposes. Generally, the communication between the network entity 110 and UE 120 may involve the exchange of management configuration and/or signaling in the downlink and the transmission of AI/ML data, reports, and/or requests in the uplink.

The UE-side AI/ML data management configuration and/or signaling provided by the network entity 110 to the UE 120 may include various control-plane messages and/or lower-layer signals that may include configurations or parameters that instruct or guide the UE 120 to perform one or more operations to appropriately collect, process, and transmit the AI/ML data, such as (but not limited to): data collection activation (e.g., configuration/structure of a request message for initiating or activating a data collection session, etc.), data marking and classification, data upload configuration, data transmission suspension and resume, mobility event and/or RRC state transition configuration, and the like. The network entity 110 may provide the UE-side AI/ML data management configuration and/or signaling to the UE 120 via various methods, such as (but not limited to) including the desired configurations or parameters into one or more Information Elements (IEs) of a Radio Resource Control (RRC) message or a Medium Access Control (MAC) Control Element (CE).

On the other hand, the UE-side AI/ML data, report, and/or request provided by the UE 120 to the network entity 110 may include the information required for the network entity 110 to determine the UE-side AI/ML data management configuration and/or deploy (e.g., train, manage, execute, etc.) one or more AI/ML models for UE-side AI/ML purposes. In addition to or in alternative to the above-mentioned AI/ML data, the UE 120 may provide a measurement report (e.g., MDT report, RRC measurement report, etc.) that contains the collected or logged AI/ML data, a measurement report that includes information that may be utilized by the network entity 110 to manage AI/ML data collection/transmission at the UE (e.g., information that indicates a mobility event and/or an RRC state transition, etc.), a request (e.g., a request initiating a data collection session, etc.), a status report that indicates the process of the data collection and the preparation of the data transmission, or the like.

According to example embodiments, the communication between the network entity 110 and UE 120 may involve a coordinated or hybrid interaction. Specifically, while the network entity 110 may provide the foundational configuration and oversight, the UE 120 may actively participate in the management of the UE-side AI/ML data by, for example, providing real-time (or near real-time) reports and data collection session requests based on its localized observations of the radio environment and/or its internal operational status. Accordingly, this bidirectional information exchange may ensure that the UE-side AI/ML data is collected and managed in an efficient, responsive, and standardized manner.

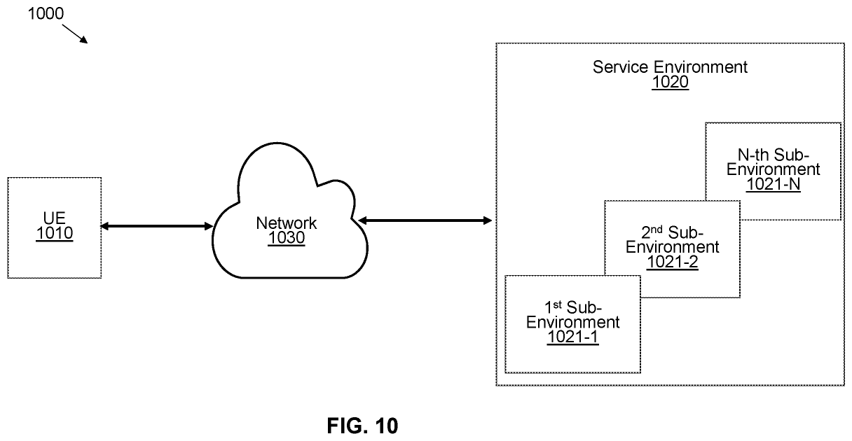

It is contemplated that the configuration in FIG. 1, as well as the described features and mechanisms, are merely examples and the scope of the present disclosure should not be limited thereto. Specifically, in some example implementations, the network entity 110 may communicate with multiple UEs, the UE 120 may communicate with multiple network entities, the network entity 110 and UE 120 may communicate with each other via an intermediate node/terminal, and the like, without departing from the scope of the present disclosure. Descriptions of an example environment that may implement the network entity 110 and UE 120 are provided below with reference to FIG. 10.

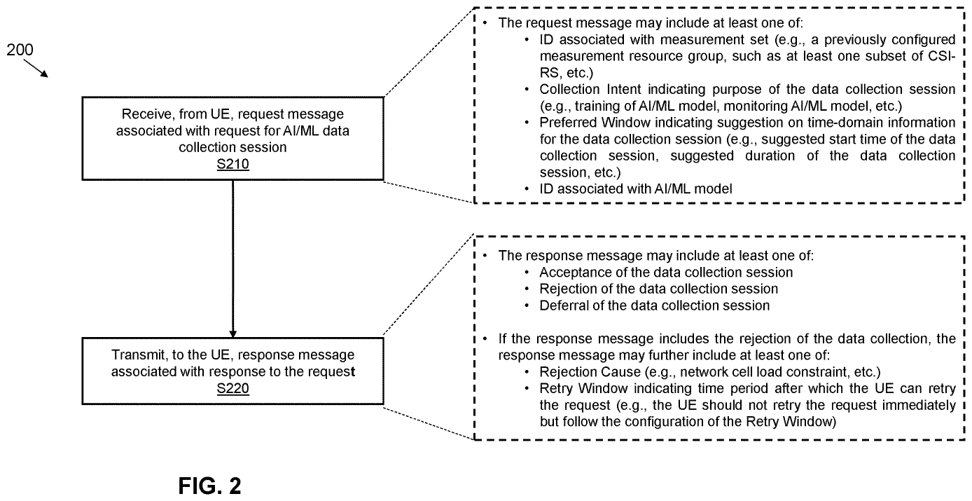

Further, it is contemplated that the network entity 110 and UE 120 may communicate and interoperate with each other to implement various methods and operations, in addition to those described above with reference to FIG. 1. For instance, as further described below with reference to FIG. 2 to FIG. 8, the network entity 110 and UE 120 may communicate and interoperate with each other to implement various methods and operations for addressing the shortcomings of the related art in each of the above-mentioned aspects (1) to (6).

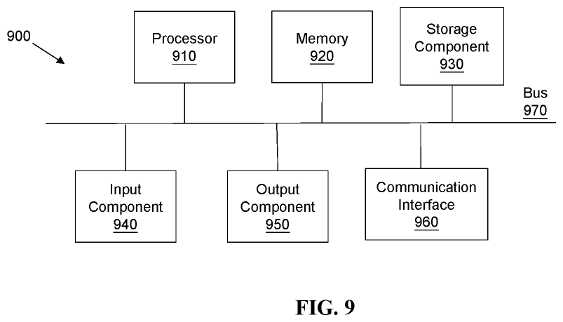

Furthermore, it is contemplated that the network entity 110 and UE 120 may further include components that may be configured to implement the associated functionalities or operations. Descriptions of various example components that may be included in (or may be configured to implement) the network entity 110 and/or UE 120 are provided below with reference to FIG. 9.

### Example Methods and Operations

Several example methods and operations, according to one or more example embodiments, are described below with reference to FIG. 2 to FIG. 8. One or more features, parameters, messages, and operations associated with FIG. 2 to FIG. 8 may be similar to those described above with reference to FIG. 1 and redundant descriptions associated therewith may be omitted below for conciseness.

For descriptive purposes, the example methods and operations may be mainly described herein as being performed by one or more specific entities, although it can be understood that, in actual implementations, another related network entity(s) and UE may perform similar/related operations, without departing from the scope of the present disclosure. For instance, an operation of a network entity (e.g., network entity 110) receiving a data/message from a UE (e.g., UE 120) may suggest or indicate an operation of the UE providing the data/message to the network entity, an operation of the network entity providing a data/message that includes data/information that guides/enables the UE to implement an operation/function may suggest or indicate an operation of the UE receiving the data/message and utilize the data/information included therein to implement the operation/function, and the like.

According to example embodiments, one or more operations of the network entity (e.g., base station, NG-RAN, core network, etc.) may be implemented in one or more apparatuses or hardware components. For instance, the network entity (or one or more associated operations) may be implemented in an apparatus/device that includes a processor and a memory storage (or any other suitable storage mediums), wherein the memory storage may include computer-executable instructions which, when executed by the processor, cause the processor to perform one or more operations thereof. An example device/apparatus that may implement the network entity (or one or more associated operations) is further described below with reference to FIG. 9.

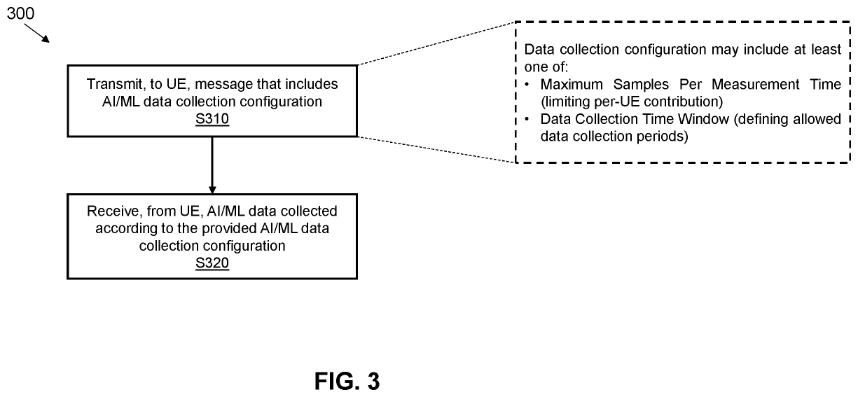

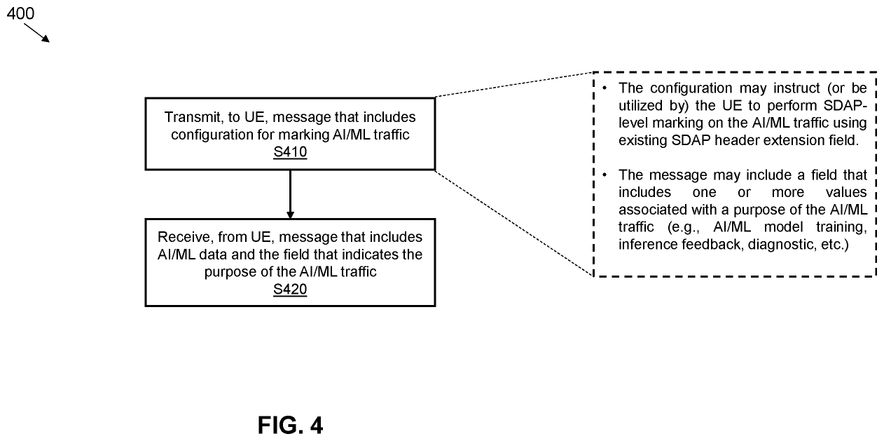

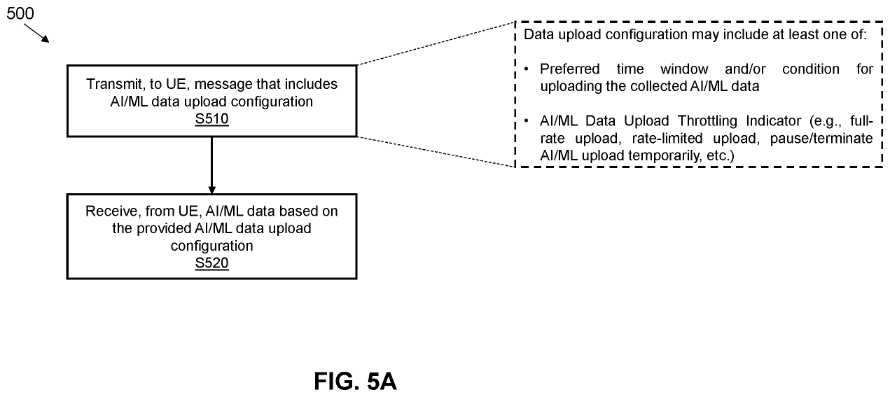

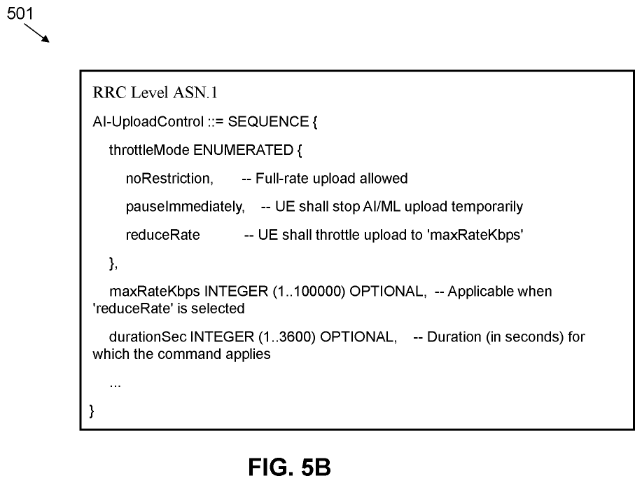

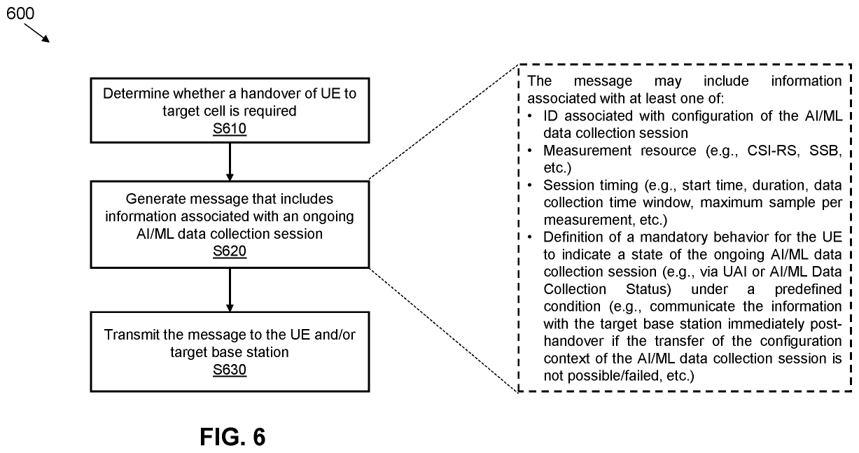

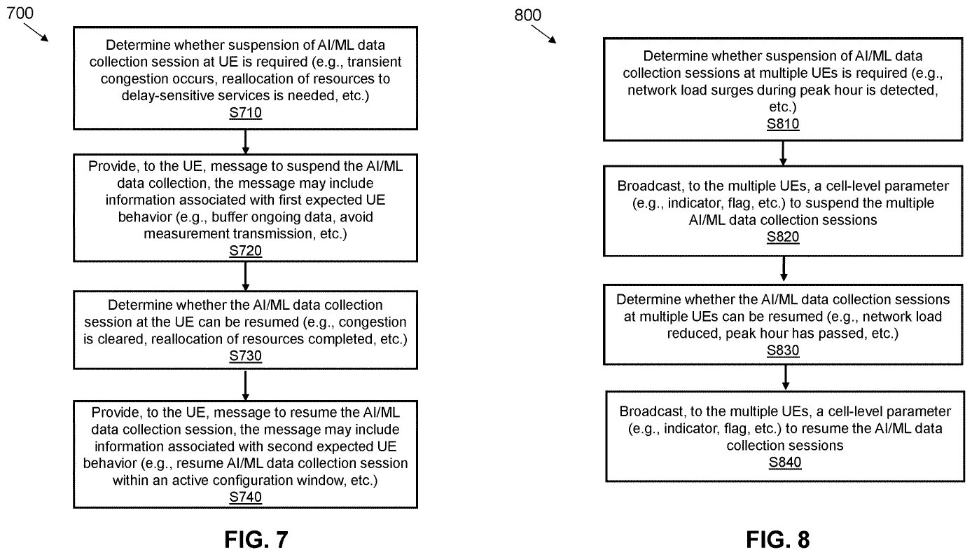

The example methods and operations in FIG. 2 to FIG. 8 may be implemented by the network entity to effectively and efficiently enhance the management of UE-side AI/ML data, thereby addressing the above-mentioned shortcomings of aspects (1) to (6). Generally, the example method and operations in FIG. 2 may be associated with aspect (1), the example method and operations in FIG. 3 may be associated with aspect (2), the example method and operations in FIG. 4 may be associated with aspect (3), the example methods and operations in FIG. 5A and FIG. 5B may be associated with aspect (4), the example method and operations in FIG. 6 may be associated with aspect (5), and the example methods and operations in FIG. 7 and FIG. 8 may be associated with aspect (6).

In this regard, although some of the methods and operations may be described separately from one another, it is contemplated that, in some example implementations, the methods and operations in two or more of FIG. 2 to FIG. 8 may be implemented by the same network entity. In this regard, it can be understood that the network entity may perform multiple methods and operations in two or more of FIG. 2 to FIG. 8 in any suitable manner (e.g., simultaneously, sequentially, etc.) and may achieve the associated technical advantages in combination. By way of a non-limiting example, although the methods and operations in FIG. 2 and FIG. 3 are associated with different aspects (and thus, are described independently from each other herein), it can be understood that the network entity may be configured to implement the methods/operations in FIG. 2 and FIG. 3 in any suitable manner (e.g., simultaneously, sequentially, etc.) to address the shortcomings of both aspect (1) and aspect (2) and achieve the technical advantages of addressing the shortcomings of both aspect (1) and aspect (2). Further, it can be understood that one or more operations in one of the FIG. 2 to FIG. 8 may be similar to or be part of one or more operations in another one of the FIG. 2 to FIG. 8. By way of a non-limiting example, one or more operations in FIG. 2 may involve one or more operations in FIG. 3, one or more operations in FIG. 3 may be performed together with one or more operations in FIG. 4, and the like. Thus, it can be understood that the descriptions of an operation with reference to one of the FIG. 2 to FIG. 8 may be applicable to another operation of another one of the FIG. 2 to FIG. 8 without departing from the scope of the present disclosure, and redundant descriptions associated therewith may be omitted below for conciseness.

Further, the methods and operations in two or more of FIG. 2 to FIG. 8 may involve the collection of data associated with one or more AI/ML models. In this regard, it can be understood that the collected data may be utilized for UE-side AI/MVL purposes, and the contents, characteristics, and intents of the collected data may be similar to the “AI/ML data,” “data collected for UE-side AI/ML purposes,” “logs,” and the like, described herein. Thus, it can also be understood that the characteristic and content of the data involved in the method and operations in one of FIG. 2 to FIG. 8 may be applicable to the data involved the method and operations in another one of FIG. 2 to FIG. 8, and redundant descriptions associated therewith may be omitted for conciseness. Similarly, it can be understood that the characteristic and content of the messages or signals (e.g., RRC message, MAC CE, request message, etc.) involved in the method and operations of one of FIG. 2 to FIG. 8 may be applicable to the messages or signals involved operations in the method and operations of another one of FIG. 2 to FIG. 8, and redundant descriptions associated therewith may be omitted below for conciseness.

### Example Methods and Operations Associated with Aspect (1)

FIG. 2 illustrates an example method 200, according to one or more example embodiments. The operations in method 200 may be performed by a network entity (e.g., network entity 110) to communicate with a UE (e.g., UE 120) to manage or control a data collection session for AI/ML data collection purposes.

As illustrated in FIG. 2, at operation S210, the network entity may be configured to receive, from the UE, a request message associated with a request for a data collection session for collecting data associated with an AI/ML model (“AI/ML data” herein). The request message may include at least one of: an identifier (ID) (“associatedID” herein) associated with a measurement set, a collection intent (“collectionIntent” herein) indicating a purpose of the data collection session, or a preferred window (“preferredWindow” herein) indicating a suggestion on time-domain information for the data collection session.

According to example embodiments, the purpose of the data collection session may include at least one of: training of the AI/ML model (e.g., fine-tuning the AI/ML model, etc.) or monitoring the AI/ML model (e.g., monitoring the performance of the AI/ML model, etc.). Additionally or alternatively, the suggestion on the time-domain information may include at least one of: a suggested start time of the data collection session or a suggested duration of the data collection session. Additionally or alternatively, the measurement set may include a previously configured measurement resource group (e.g., at least one subset of CSI-RS, etc.). In some example implementations, the request message may further include an ID associated with the AI/ML model.

According to example embodiments, the request message may include a Radio Resource Control (RRC) message. In this regard, the information of the request message (e.g., ID of measurement set, collection intent, preferred window, etc.) may be included in one or more information elements (IEs) of the RRC message. Alternatively or additionally, the request message may include a Medium Access Control (MAC) Control Element (CE). In this regard, the information of the request message may be implemented as a payload of the MAC CE that defines the intended configuration (e.g., X bits payload indicates ID X and/or collection intent X, etc.).

At operation S220, the network entity may be configured to transmit, to the UE, a response message associated with a response to the request of the data collection session. The response message may include at least one of: an acceptance of the data collection session, a rejection of the data collection session, or a deferral of the data collection session.

In this regard, the “acceptance of the data collection session” described herein may indicate that the network entity authorizes the UE to initiate the AI/ML data collection session. Upon receiving the acceptance, the UE may proceed with collecting the data according to the parameters specified in the request (such as the associated measurement resource group and the preferred time window).

On the other hand, the “rejection of the data collection session” described herein may indicate that the network entity declines the UE's request to initiate the data collection session (e.g., due to temporary constraints such as high network load, etc.). According to example embodiments, when the response message includes the rejection of the data collection session, the response message may further include at least one of: a rejection cause (“rejectionCause” herein) indicating the cause of the network entity rejecting the data collection session (e.g., network/cell load constraints, etc.), or a retry window (“retryWindow”) indicating a time period after which the UE can retry the request. The retry window may instruct the UE that it should not retry the request immediately but should follow a configured backoff period before retrying or transmitting a new request for the data collection session.

Further, the “deferral of the data collection session” described herein may indicate that the network entity acknowledges the UE's request but postpones or restricts the timing of the data collection session rather than outright rejecting it. For example, a deferral may place the data collection session in a pending state or provide the UE with specific network-defined constraints (e.g., an allowed data collection period, etc.). This allows the network entity to control when the UE initiates the data collection session to prevent uncontrolled uplink congestion, without forcing the UE to initiate a completely new request.

In view of the above, the method and operations described herein introduce and exemplify a specified and standardized structure/content of a UE-initiated data collection request message and network handling mechanism that may be implemented by a network entity (e.g., NG-RAN, etc.) to receive structured, standardized request messages from the UE that include sufficient context (e.g., measurement set ID, collection intent, preferred window, model ID, etc.) to make informed decisions about whether to accept, defer, or reject the request for the AI/ML data collection session, thereby addressing the shortcomings of aspect (1) as described above.

Advantageously, by implementing the method and operations described herein, the network entity may provide consistent, protocol-level responses that support acceptance, rejection, or deferral of data collection sessions. When rejecting requests, the network entity may provide rejection causes and retry windows, enabling the UE to implement appropriate backoff behavior rather than immediately retrying the request. This mechanism may enable consistent behavior across vendors and may provide the network with sufficient context for informed decision-making regarding AI/ML data collection sessions.

### Example Methods and Operations Associated with Aspect (2)

FIG. 3 illustrates an example method 300, according to one or more example embodiments. The operations in method 300 may be performed by a network entity (e.g., network entity 110) to communicate with a UE (e.g., UE 120) to manage or control an AI/ML data collection configuration.

As illustrated in FIG. 3, at operation S310, the network entity may be configured to transmit, to the UE, a message (“AI/MLDataCollectionConfiguration message” herein) that includes an AI/ML data collection configuration. According to example embodiments, the AI/ML data collection configuration may include at least one of: a parameter (“maxSamplesPerMeasurementTime” herein) that limits the per-UE contribution to data collection (e.g., during a measurement period, etc.), or a parameter (“collectionTimeWindow” herein) that defines allowed time periods during which the UE is permitted to perform data collection.

According to example embodiments, the message may include an RRC message. In this regard, the RRC message may include an RRC Configuration/Reconfiguration message, such as: an RRC Connection Setup message, an RRC Connection Reconfiguration message, an RRC Connection Reestablishment message, and the like. In this regard, the parameters of the AI/ML data collection configuration (e.g., maxSamplesPerMeasurementTime, collectionTimeWindow, etc.) may be included in one or more IEs of the RRC message. Alternatively or additionally, the message may include an MAC CE. In this regard, the information of the AI/ML data collection configuration may be implemented as a payload of the MAC CE that defines the intended configuration (e.g., X bits payload indicates X samples per measurement time and/or collection time window X, etc.).

At operation S320, the network entity may be configured to receive, from the UE, AI/ML data collected according to the provided AI/ML data collection configuration. Specifically, upon receiving the AI/ML data collection configuration from the network entity, the UE may collect and transmit the AI/ML data in accordance with the network-selected constraint(s) defined in the AI/ML data collection configuration.

In view of the above, the method and operations described herein introduce and exemplify a network-controlled data collection constraint mechanism that may be implemented by a network entity (e.g., NG-RAN, etc.) to provide configuration parameters that control or constrain how the UE collects AI/ML data, thereby addressing the shortcomings of aspect (2) as described above.

Advantageously, by implementing the method and operations described herein, the maxSamplesPerMeasurementTime parameter may enable the network to limit the amount of data each UE contributes during a measurement period, while the collectionTimeWindow parameter may allow the network to define specific time periods during which data collection is permitted. This approach may enable resource planning and may reduce the risk of uplink congestion that could otherwise result from overlapping or concurrent data collection activities across multiple UEs within a network cell.

### Example Methods and Operations Associated with Aspect (3)

FIG. 4 illustrates an example method 400, according to one or more example embodiments. The operations in method 400 may be performed by a network entity (e.g., network entity 110) to communicate with a UE (e.g., UE 120) to manage or control AI/ML traffic on the User Plane.

As illustrated in FIG. 4, at operation S410, the network entity may be configured to transmit, to the UE, a message that includes a configuration for marking an AI/ML traffic (i.e., a network traffic for communicating AI/ML data). According to example embodiments, the configuration may instruct or be utilized by the UE to perform Service Data Adaptation Protocol (SDAP)-level marking on the AI/ML traffic using one or more existing SDAP header extension fields. The message may include a field (“trafficPurpose field” herein) that includes one or more values associated with a purpose of the AI/ML traffic, such as at least one of: an AI/ML model training, an AI/ML inference feedback, an AI/ML model diagnostic, and the like.

According to example embodiments, the message may include an RRC message. For instance, the RRC message may include an RRC Configuration/Reconfiguration message, such as: an RRC Connection Setup message, an RRC Connection Reconfiguration message, an RRC Connection Reestablishment message, and the like. In this regard, the configuration for marking AI/ML traffic (e.g., trafficPurpose field, etc.) may be included in one or more IEs of the RRC message.

At operation S420, the network entity may be configured to receive, from the UE, a message that includes AI/ML data and the field that indicates the purpose of the associated AI/ML traffic. By receiving the message that includes the field indicating the purpose of the AI/MIL traffic, the network entity may identify and differentiate the AI/MWL traffic based on its purpose, thereby enabling the network entity to apply appropriate scheduling rules and traffic management policies that distinguish between user traffic and internal UE-generated AI/MWL data.

In view of the above, the method and operations described herein introduce and exemplify a mechanism for differentiation and control of AI/ML data on the User Plane that may be implemented by a network entity (e.g., NG-RAN, etc.) to identify AI/MVL traffic without requiring dedicated Data Radio Bearers (DRBs), thereby addressing the shortcomings of aspect (3) as described above.

Advantageously, by implementing the method and operations described herein, the network entity may efficiently differentiate AI/ML traffic from other User Plane traffic based on the trafficPurpose field, and may apply differentiated scheduling policies or resource treatment to such traffic. This SDAP-level marking mechanism may enable the network to delay, throttle, or deprioritize delay-tolerant AI/ML traffic (e.g., background model training data) relative to more time-critical services (e.g., VoNR, real-time gaming applications, etc.) without requiring dedicated DRBs with specific QoS configurations.

### Example Methods and Operations Associated with Aspect (4)

FIG. 5A illustrates an example method 500, according to one or more example embodiments. The operations in method 500 may be performed by a network entity (e.g., network entity 110) to communicate with a UE (e.g., UE 120) to manage AI/ML data upload configuration

As illustrated in FIG. 5A, at operation S510, the network entity may be configured to transmit, to the UE, a message (“AI/MLDataCollectionConfiguration” herein) that includes an AI/ML data upload configuration. According to example embodiments, the AI/ML data upload configuration may include at least one of: a preferred time window and/or a condition for uploading the collected AI/ML data, or an indicator (“AI/MLUploadThrottlingIndicator” herein) that indicates a throttling mode for uploading the AI/ML data. The preferred time window may advise the UE regarding optimal upload timing without requiring strict scheduling control. If the preferred time window is omitted, the UE may be free to upload AI/ML data at its discretion. On the other hand, the indicator may indicate the throttling mode that enables the network entity to dynamically configure or adjust the AI/ML upload priority (e.g., according to network congestion periods, etc.). Various examples of the throttling mode are further described below with reference to FIG. 5B.

At operation S520, the network entity may be configured to receive, from the UE, AI/ML data based on the provided AI/ML data upload configuration. Specifically, the UE may transmit the AI/ML data in accordance with the upload configuration parameters received at operation S510.

FIG. 5B illustrates an example data structure 501 that includes an indicator that indicates a throttling mode for uploading the AI/MVL data, according to one or more example embodiments. In this example use case, the data structure is an RRC-level Abstract Syntax Notation One (ASN.1), such as an RRC message that is written in ASN.1.

According to example embodiments, the data structure 501 may define an RRC-level sequence for controlling AI/ML data uploads from the UE to the network entity. As illustrated in FIG. 5B, the data structure 501 may include an indicator (illustrated as “throttleMode” in FIG. 5B) defined as an ENUMERATED type with three possible values: (1) a first value indicating a “noRestriction” mode, under which a full-rate AI/MVL data upload is allowed, (2) a second value indicating a “pauseImmediately” mode, instructing the UE to immediately stop AI/ML data upload (e.g., temporarily, permanently, etc.), and (3) a third value indicating a “reduceRate” mode, instructing the UE to throttle AI/ML data upload to a specified maximum rate (e.g., in Kbps, Mbps, etc.).

As also illustrated in FIG. 5B, the data structure 501 may further include a field “maxRateKbps” defined as an “OPTIONAL INTEGER” with a range of 1 to 100000, which is applicable when the “reduceRate” mode is selected. In addition, the data structure 501 may also include a field “durationSec” defined as an “OPTIONAL INTEGER” with a range of 1 to 3600, indicating the duration in seconds for which the command applies.

In view of the above, the methods and operations described herein introduce and exemplify scheduling flexibility and congestion control mechanisms that may be implemented by a network entity (e.g., NG-RAN, etc.) to advise UEs regarding optimal upload timing and to dynamically control AI/ML data uploads during congestion, thereby addressing the shortcomings of aspect (4) as described above.

Advantageously, by implementing the methods and operations described herein, the network entity may advise one or more UEs regarding optimal upload timing through the preferred time window configuration, and may dynamically control AI/ML data uploads during congestion through the throttling indicator. These mechanisms may enable the network to suggest optimal upload timing and to delay or throttle uploads dynamically during periods of network congestion. Further, the data structure 501 may exemplify a standardized RRC-level mechanism for controlling AI/ML data uploads, enabling the network entity to specify the throttle mode, maximum upload rate, and duration for which the command applies, thereby providing fine-grained control over AI/ML data upload behavior.

### Example Methods and Operations Associated with Aspect (5)

FIG. 6 illustrates an example method 600, according to one or more example embodiments. The operations in method 600 may be performed by a network entity (e.g., network entity 110) to maintain data collection context across mobility events and/or RRC state transitions for AI/ML data collection sessions. In the example of FIG. 6, a handover is utilized as the mobility event, although it is contemplated that any other suitable mobility events and/or RRC state transitions may be applicable in a similar manner, without departing from the scope of the present disclosure.

As illustrated in FIG. 6, at operation S610, the network entity may be configured to determine whether a handover of a UE (e.g., UE 120) to a target network cell is required. In this regard, it may be assumed that the network entity is a source base station that manages the source cell, and the target cell is a neighboring cell of the UE that may be managed by another base station (i.e., a target base station). The network entity may receive a measurement report (which may, but not necessarily, contain the AI/ML data) from the UE, which includes parameters that indicate the signal strength and quality of both the source cell (which is currently serving the UE) and one or more neighboring cells (which includes the target cell). Accordingly, the network entity may determine whether a handover is required by, for example, determining whether the signal strength/quality of a neighboring cell exceeds the signal strength/quality of the source cell by a predefined threshold. In this case, based on determining that the signal strength/quality of a neighboring cell exceeds the signal strength/quality of the source cell by the predefined threshold, the network entity may determine that a handover is required and select the neighboring cell as the target cell. It is contemplated that the network entity may perform any additional or alternative operations in determining whether a handover is required, without departing from the scope of the present disclosure.

Assuming that the network entity determines that a handover of the UE from a source cell to a target cell is required, method 600 may proceed to operation S620, at which the network entity may generate a message that includes information associated with an ongoing AI/ML data collection session. According to example embodiments, the message may include information associated with at least one of: an ID associated with configuration of the AI/ML data collection session, measurement resources (e.g., CSI-RS, SSB, etc.), session timing (e.g., start time, duration, data collection time window, maximum samples per measurement, etc.), or definition of a mandatory behavior for the UE to indicate a state of the ongoing AI/ML data collection session under a predefined condition. The predefined condition may include scenarios where the transfer of the configuration context of the AI/ML data collection session is not possible or has failed, in which case the UE may communicate the information with the target base station immediately post-handover via UE Assistance Information (UAI) or AI/ML Data Collection Status message.

At operation S630, the network entity may be configured to transmit the message to the UE and/or a target base station associated with the target cell. Upon successful handover, the target cell may either continue the data collection session based on the transferred context or trigger a reconfiguration as appropriate. This mechanism enables preservation of data collection context across mobility events and/or RRC state transitions, preventing session fragmentation and inconsistent training inputs that could adversely affect AI/ML model quality.

According to example embodiments, the message may include an RRC message (e.g., a handover command, an RRC Connection Reconfiguration message, etc.) that includes one or more IEs that indicate the context information associated with the active AI/ML data collection configuration. In this regard, the context information may be transmitted to the target base station via inter-node signaling (e.g., X2/Xn interface signaling, etc.) as part of the handover preparation procedure. By way of example, the network entity may transmit the message to the UE via RRC signaling (e.g., including the information of the ongoing AI/ML data collection session in an RRC Reconfiguration message, etc.), and/or transmit the message to the target base station via inter-base station signaling (e.g., Next Generation Application Protocol (NGAP) signaling, etc.).

In view of the above, the method and operations described herein introduce and exemplify a context transfer mechanism that may be implemented by a network entity (e.g., NG-RAN, etc.) to preserve data collection context across mobility events e.g., handovers), preventing session fragmentation and inconsistent training inputs that could adversely affect AI/ML model quality and thereby addressing the shortcomings of aspect (5) as described above.

Advantageously, by implementing the method and operations described herein, the network entity may extend handover preparation signaling to optionally include the active AI/ML data collection configuration context. Further, if context transfer is not possible or fails, the UE may be required to indicate its ongoing data collection state to the target base station immediately post-handover via UAI or AI/ML Data Collection Status, thereby ensuring that the target network cell is informed of the UE's ongoing AI/ML data collection activities and may take appropriate actions to continue or reconfigure the AI/ML data collection session. This approach may be particularly beneficial in deployment scenarios involving distributed model training architectures, where continuity of collected data under stable measurement assumptions may be important for maintaining AI/ML model quality and training convergence.

### Example Methods and Operations Associated with Aspect (6)

FIG. 7 illustrates an example method 700, according to one or more example embodiments. The operations in method 700 may relate to runtime control of ongoing AI/MVL data collection sessions at the UE-level.

As illustrated in FIG. 7, at operation S710, the network entity may be configured to determine whether suspension of an AI/ML data collection session at a UE (e.g., UE 120) is required. This determination may be based on conditions such as: transient congestion occurring, reallocation of resources to delay-sensitive services being needed, or similar network conditions.

Based on determining that the suspension of the AI/ML data collection session at the UE is required, method 700 may proceed to operation S720, at which the network entity may be configured to provide, to the UE, a message to suspend the AI/ML data collection. The message may include information associated with first expected UE behavior, such as buffering ongoing data, avoiding measurement transmission, and similar actions. According to example embodiments, the message may include lightweight signaling such as an RRC message or a MAC CE, thereby enabling the network entity to suspend the AI/ML data collection session without requiring full reconfiguration procedures. Upon receiving the message, the UE may suspend the AI/ML data collection session accordingly.

Upon providing the message to the UE, at operation S730, the network entity may be configured to determine whether the AI/ML data collection session at the UE can be resumed. This determination may be based on conditions such as: congestion being cleared, reallocation of resources being completed, or similar factors.

Based on determining that the AI/ML data collection session at the UE can be resumed, method 700 may proceed to operation S740, at which the network entity may be configured to provide, to the UE, a message to resume the AI/ML data collection session. The message may include information associated with second expected UE behavior, such as resuming the AI/ML data collection session within an active configuration window. According to example embodiments, the message may include lightweight signaling such as an RRC message or a MAC CE, thereby enabling the network entity to resume the AI/ML data collection session without requiring full reconfiguration procedures. Upon receiving the message, the UE may resume the AI/ML data collection session accordingly.

FIG. 8 illustrates an example method 800, according to one or more example embodiments. The operations in method 800 may relate to runtime control of ongoing AI/ML data collection sessions at a cell level. In this regard, method 800 may provide coarse-grain cell-level control applicable to multiple UEs using shared configurations, enabling network-wide management when desired (e.g., during network load surges, etc.).

As illustrated in FIG. 8, at operation S810, the network entity may be configured to determine whether suspension of AI/ML data collection sessions at multiple UEs is required. This determination may be based on conditions such as: network load surges during peak hours being detected, or similar network-wide conditions.

Based on determining that the suspension of the AI/ML data collection sessions at the multiple UEs is required, method 800 may proceed to operation S820, at which the network entity may be configured to broadcast a cell-level parameter (“AIMLCollectionSuspensionIndicator” herein) to the multiple UEs to suspend the multiple AI/ML data collection sessions. The cell-level parameter may include an indicator, flag, or similar signaling element, which is applicable to multiple UEs using shared configurations. According to example embodiments, the cell-level parameter may be broadcast via system information or other cell-wide signaling mechanisms, thereby enabling the network entity to simultaneously suspend AI/ML data collection activities across multiple associated UEs within the network cell without requiring individual signaling to each UE.

Upon broadcasting the cell-level parameter to the multiple UEs, at operation S830, the network entity may be configured to determine whether the AI/ML data collection sessions at the multiple UEs can be resumed. This determination may be based on conditions such as: network load being reduced, peak hours having passed, or similar factors.

Based on determining that the AI/ML data collection sessions at the multiple UEs can be resumed, method 800 may proceed to operation S840, at which the network entity may be configured to broadcast a cell-level parameter to the multiple UEs to resume the AI/ML data collection sessions. The cell-level parameter may include an indicator, flag, or similar signaling element.

In this regard, method 800 may provide coarse-grain cell-level control applicable to multiple UEs using shared configurations, enabling network-wide management during load surges. By broadcasting a single cell-level parameter, the network entity may efficiently suppress or resume AI/ML data collection activities across multiple UEs simultaneously, thereby reducing the signaling overhead that would otherwise be required if individual suspension/resumption messages were sent to each UE.

In view of the above, the methods and operations described herein introduce and exemplify lightweight runtime control mechanisms that may be implemented by a network entity (e.g., NG-RAN, etc.) to temporarily suspend or resume data collection at one or more UEs, without invoking full reconfiguration procedures, providing lightweight control mechanisms for transient congestion conditions or temporary resource reallocation scenarios. This lightweight suspension/resumption signaling and the cell-level suspension indicator may provide standardized support for temporary suspension or resumption of data collection by the network. In this way, the network entity may suppress low-priority collection activities during peak usage periods without requiring complete session teardown or full reconfiguration, while retaining the ability to resume data collection when network conditions improve, thereby addressing the shortcomings of aspect (6) as described above.

### Summary

In view of the above, FIG. 2 to FIG. 8 illustrate various example methods and operations that may be implemented to address the shortcomings of the above-described aspects (1)-(6), thereby enabling effective and efficient enhancement on UE-side AI/ML data management, particularly on the collection and transmission of the associated AI/ML data.

It is contemplated that the methods, operations, advantages, and significances described above with reference to FIG. 2 to FIG. 8 are merely examples, and the scope of the present disclosure should not be limited thereto. Specifically, one or more operations in FIG. 2 to FIG. 8 may be performed differently, less or additional operations may be involved, the messages or commands involved therein may include less or additional parameters, additional advantages may be achieved, and the like, without departing from the scope of the present disclosure. Further, it is contemplated that one or more of the above-described parameters, messages, and the like, may be consistent with those specified in one or more standard specifications, with additional parameters, attributes, and mechanisms supplemented thereto (when required). Further, multiple methods and operations in FIG. 2 to FIG. 8 may be performed in combination with each other, without departing from the scope of the present disclosure.

### Examples of Device

One or more components of the example embodiments (e.g., network entity, UE, etc.), as well as the operations associated therewith, may be implemented in one or more devices or hardware components. For instance, one or more components/operations of the network entity may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods associated with the network entity may be performed by at least one processor of the device upon executing machine-readable instructions or computer-readable instructions stored in a memory or a storage component of the device.

FIG. 9 illustrates an embodiment of a device 900. As shown in FIG. 9, the device 900 may include a processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, instructions to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

### Example Implementation Environment

Example embodiments of the present disclosure may be implemented in any suitable type of environment. In the following, an example environment (in which the example embodiments may be implemented) is described.

FIG. 10 illustrates a diagram of an example environment 1000 in which systems and/or methods, described herein, may be implemented. The implementation environment 1000 includes a UE (User equipment) 1010, a service environment 1020, and a network 1030. The service environment 1020 includes one or more sub-environments 1021. To illustrate this, FIG. 10 shows, for convenience, examples of a 1st sub-environment 1021-1, a 2nd sub-environment 1021-2, and an N-th sub-environment 1021-N(where N is any natural number).

The UE 1010 is connected to the network 1030, and the network 1030 is connected to the service environment 1020. The connections may be wired, wireless, or a combination of both wired and wireless. The UE 1010 and the service environment 1020 are connected via the network 1030.

The UE 1010 is a device that communicates with the service environment 1020. The UE 1010 receives information from the service environment 1020 and/or sends information to the service environment 1020. Also, the UE 1010 may generate and/or store information to be transmitted, as necessary. Also, the UE 1010 may store and/or process information that is received, as necessary.

The example FIG. 10 refers to the “UE”. However, it should be understood by those skilled in the art that general terms such as “user device,” “terminal,” “terminal device,” “communication device,” and “communication terminal” can be used interchangeably with the term “UE.”

For example, the UE 1010 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 1020 is an environment that communicates with the UE 1010 to provide one or more services. The service environment 1020 receives information from the UE 1010 and/or sends information to the UE 1010. Also, the service environment 1020 may generate and/or store information to be transmitted, as necessary. Also, the service environment 1020 may store and/or process information that is received, as necessary. For example, the service environment 1020 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 10 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 1020 is not specifically limited and can be adjusted according to the embodiments. For example, the services may include a service that provides information to the UE 1010, a service that stores information from the UE 1010, or a service that performs processing based on information from the UE 1010 and returns the results of the processing.

In an embodiment, the Service Environments 1020 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 1020 includes one or more devices, such as servers and network devices, which provide services or perform processes. The placement of these devices within the service environment 1020 can be determined as appropriate. Additionally, if the service environment 1020 includes one or more sub-environments 1021, the placement of devices can be determined based on predetermined policies for each sub-environment 1021. For example, devices related to the first service may be placed in the 1st sub-environment 1021-1, and devices related to the second service may be placed in the 2nd sub-environment 1021-2. In another example, devices expected to have a higher load than a predetermined threshold may be placed in the 1st sub-environment 1021-1, while devices expected to have a lower load than the predetermined threshold may be placed in the 2nd sub-environment 1021-2. In this way, specific devices can be placed in specific sub-environments 1021. Conversely, each sub-environment 1021 can be specialized for a particular purpose.

In an embodiment, all processes executed in a single service may run within a single service environment, or in multiple service environments. Multiple processes executed in a single service could be provided by different service environments.

The network 1030 is a network that exchanges information between the UE 1010 and the service environment 1020. The network 1030 includes one or more wired and/or wireless networks.

For example, the network 1030 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 1030 can be a part of a network. For example, in a 5G network that includes a RAN, a transport network, and a core network, the network 1030 can be at least one of the RAN, the transport network, or the core network. For example, the service environment 1020 could be in the core network, in which case the network 1030 could correspond to a network that is a combination of a RAN and a transport network and is part of the 5G network.

In this regard, the UE 1010 in FIG. 10 may be similar to the UE 120 in FIG. 1, while the network entity 110 in FIG. 1 may be implemented in the network 1030. Further, the AI/ML-related operations described herein (e.g., AI/ML model training, AI/ML inference, etc.) may be implemented in the service environment 1020.

The number and arrangement of devices and networks shown in FIG. 10 are provided as an example. It should be understood that any changes that may be implemented by those skilled in the art, such as the addition or rearrangement of well-known devices or networks at the time of implementation, are included in this disclosure.

### Various Aspects of Embodiments

Example embodiments introduces new parameters, attributes, mechanisms, and features that supplement and enhance the disclosures of one or more standard specifications. As a non-limiting example, example embodiments supplement and enhance at least one technical documents associated with 3GPP Technical Specification Group-Radio Access Network (TSG-RAN) Working Group 2 (WG2). Specifically, the following disclosures where introduced by the example embodiments of the present disclosure during the 3GPP TSG-RAN WG2 Meeting

```
1 Introduction
Following agreements were made in RAN2#129 on UE Side Data Collection, This contribution discusses
additional aspects of UE side data collection especially focusing on how to control the UE Side data
collection from NW Side.
RAN2#129 discussed UE-side data collection for the UE-side use cases (including the beam
management use case), focusing on data collection configuration, and made the following
agreements:
    - Extend the following agreements on data collection configuration in AI/ML based beam
      management to general UE-side data collection configuration:
        ○ Data collection related configuration(s) and associated ID(s)(if needed) can be
          included in training data collection configuration.
        ○ For data collection configuration UE-side model training, the UE can send a request
          for data collection (e.g. start/stop). FFS whether a suggested data collection
          configuration/associated IDs (if specified)/parameters can be provided to the
          network.
        ○ The network can provide or release the data collection configuration (at any point in
          time), with or without UE request.
        ○ The following methods for network control of the initiation and configuration for
          data collection:
            - The network can decide when to start/stop the data collection and send
              configuration.
            - The network can configure whether UE is allowed to initiate request for
              data collection (e.g. start/stop indication).
2 Discussion
2.1 UE-Initiated Collection Requests and NG-RAN Handling
The agreements at RAN2#129 allow the UE to initiate data collection via RRC signaling, but the structure
and semantics of the request remain undefined. In practice, AI/ML data collection sessions may involve
distinct measurement resource groups (e.g., CSI-RS subsets), associated model IDs, and timing
preferences. Without standardized fields in the request, NG-RAN lacks sufficient context to make
informed decisions about whether to authorize or reject the request.
Moreover, the NG-RAN's policy in handling such requests is not yet fully specified. To support
consistent behavior across vendors, the decision to accept, defer, or reject collection must be explicitly
supported at the protocol level.
Proposal 1: Define a new RRC message AIDataCollectionRequest containing optional IEs:
  1.a associatedID: referencing a previously configured measurement set
  1.b collectionIntent: indicating training or monitoring
  1.c preferredWindow: a suggested start time or duration for collection
Proposal 1-1: Extend the response to include rejectionCause and optional retry Window. If the NG-RAN
declines the request (e.g., due to cell load), the UE should not retry immediately but follow the configured
backoff.
2.2 Network-Controlled Constraints for UE-Side Data Collection
Although full scheduling of UE collection by NG-RAN is not desirable due to signaling overhead,
operators need a means to define basic constraints, such as:
  - How frequently UEs can collect data
  - When collection is allowed
These constraints enable resource planning and reduce the risk of uplink congestion caused by
overlapping data collection from many UEs.
Observation 1:
The absence of network-defined constraints for collection frequency and timing may lead to uncontrolled
uplink behavior and complicate scheduling.
Proposal 2:
Introduce a new IE AIMLDataCollectionConstraint in AIMLDataCollectionConfiguration message.
This IE includes:
  - maxSamplesPermeaurementtime: limiting per-UE contribution
  - collectionTime Window: defining allowed collection periods
2.3 Differentiation and Control of AI/ML Data on the User Plane
It seem that AI/ML data collected by the UE will be transported via existing DRBs or QFI-based flows.
However, these data flows are indistinguishable from other best-effort traffic. This limits the NG-RAN's
ability to apply differentiated scheduling or resource treatment. Furthermore, in cells with high uplink
load, uncontrolled AI/ML uploads may interfere with latency-sensitive services.
Given that AI/ML data is usually non-time-critical, the NG-RAN should be able to delay, throttle, or
deprioritize such traffic. Doing so requires some degree of identification—preferably at the SDAP layer.
Observation 2:
AI/ML data flows are opaque to NG-RAN, and cannot be deprioritized or shaped unless they are carried
in dedicated DRBs, which are not always justified.
Proposal 3:
Introduce a new SDAP-level marking for AI/ML traffic using existing SDAP header extension fields
(TS 38.321). Define a trafficPurpose field with values such as:
  - training
  - inferenceFeedback
  - diagnostic
This allows the NG-RAN to apply scheduling rules that distinguish between user traffic and internal UE-
generated AI data.
2.4 Scheduling Flexibility and Congestion Control for AI/ML Uploads
UEs may collect and store large amounts of measurement data, uploading them asynchronously during
idle or low-load periods, the network doesn't have a mechanism to suggest optimal upload timing or to
delay uploads dynamically during congestion. AI/ML data uploads would be able to tolerate moderate
latency, making them suitable for scheduled or rate-controlled transmission—if such control
mechanisms are defined..
Observation 3:
There is no RRC-level mechanism for the NG-RAN to advise the UE when to upload AI/ML data, nor
any congestion signaling specific to such traffic.
Proposal 4-1: Define a new optional IE AIMLUploadWindow in AIMLDataCollectionConfiguration,
specifying preferred time windows or conditions for data upload. If omitted, the UE is free to upload at
its discretion.
Proposal 4-2: Introduce a new RRC/MAC-level indication AIMLUploadThrottling Indicator, allowing
the NG-RAN to dynamically reduce AI/ML upload priority during congestion periods. This can be
mapped to uplink scheduling behavior or DRB suspension.
  RRC Level ASN.1
  AI-UploadControl ::= SEQUENCE {
    throttle Mode ENUMERATED {
      noRestriction,  -- Full-rate upload allowed
      pauseImmediately, -- UE shall stop AI/ML upload temporarily
      reduce Rate  -- UE shall throttle upload to ‘maxRateKbps’
    },
    maxRate Kbps INTEGER (1..100000) OPTIONAL, -- Applicable when 'reduceRate' is
  selected
    durationSec INTEGER (1..3600) OPTIONAL, -- Duration (in seconds) for which the
  command applies
    ...
  }
2.5 Maintaining Data Collection Context Across Mobility and RRC state Transitions
UEs collecting data for AI/ML training typically should not over extended time windows and may remain
in the same collection session across multiple cell changes. In the current specification, there is no
guarantee that the associated configuration — including measurement resources, collection intent, or
associatedID — is valid in the target cell post-handover. If not maintained, the result may be an
unintended collection gap, wasted radio resources, or model inconsistency.
While handover mechanisms already support transferring measurement configurations and DRB context,
there is no equivalent transfer for data collection session metadata. Without such support, the UE must
treat mobility as the end of one session and re-request a new one, which adds signaling and causes
collection delay.
This is particularly problematic in deployments involving distributed model training, where continuity
of collected data under stable measurement assumptions is essential to maintain model quality.
Observation 4:
Data collection context is not preserved across intra- mobility events, risking session fragmentation and
inconsistent training inputs.
Proposal 5:
Extend the handover preparation signaling to optionally include the active
AIMLDataCollectionConfiguration context, including associatedID, measurement resources, and
session timing. Upon successful handover, the target cell shall either continue the session or trigger a
reconfiguration.
Proposal 5-1: If context transfer is not possible define a mandatory behavior for the UE to indicate its
ongoing collection state via UAI or AIMLDataCollectionStatus immediately post-handover.
2.6 Runtime Control of Ongoing Collection Sessions
Collection sessions may be initiated through configuration, but they are not always ideal to run
continuously without adaptive control. In practical scenarios, UE power conditions, cell load, or uplink
scheduling capacity may vary, requiring dynamic throttling or suspension of collection.
The current discussions in RAN2 offers only start and stop through configuration. This binary approach
increases signaling and limits flexibility. A lighter-weight control interface is required, especially for
cases where the network prefers to momentarily pause data collection due to transient congestion or to
reallocate resources to delay-sensitive services.
Operators deploying AI/ML-based features at scale would be particularly concerned about the
background nature of collection traffic overwhelming scheduling queues during peak hours. The RAN
should be able to suppress low-priority collection during such periods — without needing to tear down
or reconfigure the entire session.
Observation 5:
There is no support for temporary suspension or resumption of collection by NG-RAN without full
reconfiguration.
Proposal 6:
Introduce a lightweight RRC signaling (or MAC CE if applicable) to suspend or resume AI/ML data
collection at the UE. Define expected UE behavior: buffer ongoing data, avoid measurement
transmission, and resume within the active configuration window.
Proposal 6-1:
Allow the NG-RAN to broadcast a cell-level AIMLCollectionSuspensionIndicator applicable to all UEs
using shared configurations. This provides coarse-grain control during load surges.
3 Conclusion
In summary, the following are presented:
UE-Initiated Collection Requests and NG-RAN Handling
Proposal 1:
Define a new RRC message AIDataCollectionRequest containing optional IEs:
  1.a associatedID: referencing a previously configured measurement set
  1.b collectionIntent: indicating training or monitoring
  1.c preferredWindow: a suggested start time or duration for collection
Proposal 1-1:
Extend the response to include rejectionCause and optional retryWindow. If the NG-RAN declines the
request (e.g., due to cell load), the UE should not retry immediately but follow the configured backoff.
Network-Controlled Constraints for UE-Side Data Collection
Observation 1:
The absence of network-defined constraints for collection frequency and timing may lead to uncontrolled
uplink behavior and complicate scheduling.
Proposal 2:
Introduce a new IE AIMLDataCollectionConstraint in AIMLDataCollectionConfiguration message.
This IE includes:
  - maxSamplesPermeaurementtime: limiting per-UE contribution
  - collection Time Window: defining allowed collection periods
Differentiation and Control of AI/ML Data on the User Plane
Observation 2:
AI/ML data flows are opaque to NG-RAN, and cannot be deprioritized or shaped unless they are carried
in dedicated DRBs, which are not always justified.
Proposal 3:
Introduce a new SDAP-level marking for AI/ML traffic using existing SDAP header extension
fields (TS 38.321). Define a trafficPurpose field with values such as:
  - training
  - inferenceFeedback
  - diagnostic
  -
This allows the NG-RAN to apply scheduling rules that distinguish between user traffic and
internal UE-generated AI/ML data.
Scheduling Flexibility and Congestion Control for AI/ML Uploads
Observation 3:
There is no RRC-level mechanism for the NG-RAN to advise the UE when to upload AI/ML
data, nor any congestion signaling specific to such traffic.
Proposal 4-1:
Define a new optional IE AIMLUploadWindow in AIMLDataCollectionConfiguration,
specifying preferred time windows or conditions for data upload. If omitted, the UE is free to
upload at its discretion.
Proposal 4-2:
Introduce a new RRC/MAC-level indication AIUploadThrottlingIndicator, allowing the NG-
RAN to dynamically reduce AI/ML upload priority during congestion periods. This can be
mapped to uplink scheduling behavior or DRB suspension.
Maintaining Data Collection Context Across Mobility and RRC state Transitions
Observation 4:
Data collection context is not preserved across intra- mobility events, risking session
fragmentation and inconsistent training inputs.
Proposal 5: Extend the handover preparation signaling to optionally include the active
AIMLDataCollectionConfiguration context, including associatedID, measurement resources,
and session timing. Upon successful handover, the target cell shall either continue the session
or trigger a reconfiguration.
Proposal 5-1:
If context transfer is not possible define a mandatory behavior for the UE to indicate its ongoing
collection state via UAI or AIMLDataCollectionStatus immediately post-handover.
Runtime Control of Ongoing Collection Sessions
Observation 5:
There is no support for temporary suspension or resumption of collection by NG-RAN without
full reconfiguration.
Proposal 6:
Introduce a lightweight RRC signaling (or MAC CE if applicable) to suspend or resume AI/ML
data collection at the UE. Define expected UE behavior: buffer ongoing data, avoid
measurement transmission, and resume within the active configuration window.
Proposal 6-1:
Allow the NG-RAN to broadcast a cell-level AIMLCollectionSuspensionIndicator applicable to
all UEs using shared configurations. This provides coarse-grain control during load surges.
```

In view of the above, example embodiments introduce clarified, specified, and standardized approaches for implementing the enhancement of UE-side AI/ML data management in the 3GPP-based network architecture. Specifically, example embodiments clarify how specifically the 3GPP defined frameworks and architectures (e.g., RRC signaling, SDAP-layer operation, etc.) can be utilized to enhance UE-side AI/ML data management. Accordingly, the example embodiments may be implemented in the 3GPP-based networks in a clear and standardized manner.

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system comprising: a network entity configured to: receive, from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and transmit, to the UE, a response message associated with a response to the request of the data collection session, wherein the response message comprises at least one of: an acceptance of the data collection session, a rejection of the data collection session, or a deferral of the data collection session.
Item [2]: The system according to item [1], wherein the response message comprises the rejection of the request, and wherein the response message further comprises at least one of: a rejection cause, or a retry window indicating a time period after which the UE can retry the request.
Item [3]: The system according to one or more of items [1]-[2], wherein the request message comprises a radio resource control (RRC) message.
Item [4]: The system according to one or more of items [1]-[3], wherein the purpose of the data collection session comprises at least one of: training the AI/ML model or monitoring the AI/ML model.
Item [5]: The system according to one or more of items [1]-[4], wherein the suggestion on the time-domain information comprises at least one of: a suggested start time of the data collection session or a suggested duration of the data collection session.
Item [6]: The system according to item [2], wherein the rejection cause comprises a network cell load constraint.
Item [7]: The system according to one or more of items [1]-[6], wherein the measurement set comprises a previously configured measurement resource group, and wherein the measurement resource group comprises at least one subset of channel state information reference signals (CSI-RS).
Item [8]: The system according to one or more of items [1]-[7], wherein the request message further includes an ID associated with the AI/ML model.
Item [9]: A method comprising: receiving, from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and transmitting, to the UE, a response message associated with a response to the request of the data collection session, wherein the response message comprises at least one of: an acceptance of the data collection session, a rejection of the data collection session, or a deferral of the data collection session.
Item [10]: The method according to item [9], wherein the response message comprises the rejection of the request, and wherein the response message further comprises at least one of: a rejection cause, or a retry window indicating a time period after which the UE can retry the request.
Item [11]: The method according to one or more of items [9]-[10], wherein the request message comprises a radio resource control (RRC) message.
Item [12]: The method according to one or more of items [9]-[11], wherein the purpose of the data collection session comprises at least one of: training the AI/ML model or monitoring the AI/ML model.
Item [13]: The method according to one or more of items [9]-[12], wherein the suggestion on the time-domain information comprises at least one of: a suggested start time of the data collection session or a suggested duration of the data collection session.
Item [14]: The method according to item [10], wherein the rejection cause comprises a network cell load constraint.
Item [15]: The method according to one or more of items [9]-[14], wherein the measurement set comprises a previously configured measurement resource group, and wherein the measurement resource group comprises at least one subset of channel state information reference signals (CSI-RS).
Item [16]: The method according to one or more of items [9]-[15], wherein the request message further includes an ID associated with the AI/ML model.
Item [17]: A non-transitory computer-readable recording medium having recorded thereon instructions executable by a network entity to cause the network entity to perform a method comprising: receiving, from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and transmitting, to the UE, a response message associated with a response to the request of the data collection session, wherein the response message comprises at least one of: an acceptance of the data collection session, a rejection of the data collection session, or a deferral of the data collection session.
Item [18]: The non-transitory computer-readable recording medium according to item [17], wherein the response message comprises the rejection of the request, and wherein the response message further comprises at least one of: a rejection cause, or a retry window indicating a time period after which the UE can retry the request.
Item [19]: The non-transitory computer-readable recording medium according to one or more of items [17]-[18], wherein the request message comprises a radio resource control (RRC) message.
Item [20]: The non-transitory computer-readable recording medium according to one or more of items [17]-[19], wherein the purpose of the data collection session comprises at least one of: training of the AI/ML model or monitoring of the AI/ML model.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a network entity configured to:
receive, from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and
transmit, to the UE, a response message associated with a response to the request of the data collection session, wherein the response message comprises at least one of: an acceptance of the data collection session, a rejection of the data collection session, or a deferral of the data collection session.

2. The system according to claim 1, wherein the response message comprises the rejection of the request, and wherein the response message further comprises at least one of: a rejection cause, or a retry window indicating a time period after which the UE can retry the request.

3. The system according to claim 1, wherein the request message comprises a radio resource control (RRC) message.

4. The system according to claim 1, wherein the purpose of the data collection session comprises at least one of: training the AI/ML model or monitoring the AI/ML model.

5. The system according to claim 1, wherein the suggestion on the time-domain information comprises at least one of: a suggested start time of the data collection session or a suggested duration of the data collection session.

6. The system according to claim 2, wherein the rejection cause comprises a network cell load constraint.

7. The system according to claim 1, wherein the measurement set comprises a previously configured measurement resource group, and wherein the measurement resource group comprises at least one subset of channel state information reference signals (CSI-RS).

8. The system according to claim 1, wherein the request message further includes an ID associated with the AI/ML model.

9. A method comprising:
receiving, by a network entity and from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and
transmitting, by the network entity and to the UE, a response message associated with a response to the request of the data collection session, wherein the response message comprises at least one of: an acceptance of the data collection session, a rejection of the data collection session, or a deferral of the data collection session.

10. The method according to claim 9, wherein the response message comprises the rejection of the request, and wherein the response message further comprises at least one of: a rejection cause, or a retry window indicating a time period after which the UE can retry the request.

11. The method according to claim 9, wherein the request message comprises a radio resource control (RRC) message.

12. The method according to claim 9, wherein the purpose of the data collection session comprises at least one of: training the AI/ML model or monitoring the AI/ML model.

13. The method according to claim 9, wherein the suggestion on the time-domain information comprises at least one of: a suggested start time of the data collection session or a suggested duration of the data collection session.

14. The method according to claim 10, wherein the rejection cause comprises a network cell load constraint.

15. The method according to claim 9, wherein the measurement set comprises a previously configured measurement resource group, and wherein the measurement resource group comprises at least one subset of channel state information reference signals (CSI-RS).

16. The method according to claim 9, wherein the request message further includes an ID associated with the AI/ML model.

17. A non-transitory computer-readable recording medium having recorded thereon instructions executable by a network entity to cause the network entity to perform a method comprising:
receiving, from a user equipment (UE), a request message associated with a request for a data collection session for collecting data associated with an Artificial Intelligence or Machine Learning (AI/ML) model, wherein the request message comprises at least one of: an identifier (ID) associated with a measurement set, a collection intent indicating a purpose of the data collection session, or a preferred window indicating a suggestion on time-domain information for the data collection session; and
transmitting, to the UE, a response message associated with a response to the request of the data collection session, wherein the response message comprises at least one of: an acceptance of the data collection session, a rejection of the data collection session, or a deferral of the data collection session.

18. The non-transitory computer-readable recording medium according to claim 17, wherein the response message comprises the rejection of the request, and wherein the response message further comprises at least one of: a rejection cause, or a retry window indicating a time period after which the UE can retry the request.

19. The non-transitory computer-readable recording medium according to claim 17, wherein the request message comprises a radio resource control (RRC) message.

20. The non-transitory computer-readable recording medium according to claim 17, wherein the purpose of the data collection session comprises at least one of: training of the AI/ML model or monitoring of the AI/ML model.
